(19) United States
(12) Patent Application Publication
(10) Pub. No.: US 2026/0359571 A1
(43) Pub. Date: Nov. 12, 2026

(54) Multilingual Entity Mention Detection Using a Late-Fusion Transformer and Named-Entity-Recognition Architecture with Script-Aware Post-Filter Verification

(71) Applicant: Zscaler, Inc., San Jose, CA (US)

(72) Inventors: Kaustav Saha, Fremont, CA (US); Shwetank Raghuvanshi, San Ramon, CA (US); Batool Haider, Lawrence, KS (US); Kliton Andrea, Hanover, MA (US); Chenhui Hu, Lexington, MA (US); Subramanian Srinivasan, Milpitas, CA (US); Ashwin Kesireddy, San Jose, CA (US)

(73) Assignee: Zscaler, Inc., San Jose, CA (US)

(21) Appl. No.: 19/685,494

(22) Filed: May 22, 2026

Related U.S. Application Data
(60) Provisional application No. 63/990,633, filed on Feb. 25, 2026.

(51) Int. Cl. G06F 40/295

(52) U.S. Cl. CPC G06F 40/295

(57) ABSTRACT

A system and method for detecting entity mentions in multilingual text are disclosed. A shared multilingual transformer encoder produces a pooled representation from a tokenized representation of an item of text. A named-entity-recognition (NER) feature extraction module produces an NER feature vector from the item of text and a configured entity list, the NER feature vector including exact-match, fuzzy-similarity, entity-overlap, organization-entity, position-score, and mention-frequency components. A late-fusion concatenation module concatenates the pooled representation with the NER feature vector after and external to encoder layers of the shared multilingual transformer encoder to form a joint representation. A classification head produces an entity-mention probability from the joint representation. A multi-guard post-filter chain compares the entity-mention probability to a configurable threshold and applies a plurality of sequential guards, with at least one guard short-circuited in response to a script family of the item of text being a non-Latin script family.

### CROSS-REFERENCE TO RELATED APPLICATION(S)

The present application claims the benefit of priority to U.S. Provisional Patent Application No. 63/990,633, filed Feb. 25, 2026, and entitled “Hybrid Multilingual Competitor Mention Detection Using Late-Fusion Contextual Embeddings and Named-Entity Features with Multi-Guard Post-Filter Verification,” the entire contents of which are hereby incorporated by reference.

### FIELD OF THE DISCLOSURE

The present disclosure relates generally to machine learning systems for automated content inspection. More particularly, the present disclosure relates to systems and methods for detecting entity mentions in multilingual text using a late-fusion architecture that combines a contextualized representation from a multilingual transformer encoder with a named-entity-recognition (NER) feature vector, followed by a script-aware post-filter verification chain.

### BACKGROUND OF THE DISCLOSURE

Enterprise adoption of generative artificial intelligence (AI) has introduced a category of compliance risk in which text generated by or transmitted through enterprise applications may reference competitor products, draw unfavorable comparisons, or disclose market-intelligence information without user intent. Text flowing through chatbot platforms, content generation pipelines, internal knowledge assistants, and regulated-industry gateways is to be inspected in real time across a plurality of languages and script families, under latency budgets incompatible with large language model (LLM) based classification.

Conventional approaches to entity mention detection fall into three categories, each with known limitations. Keyword blocklist approaches perform case-insensitive substring matching against a list of entity names. Such approaches are computationally efficient but suffer from substring-collision false positives, in which an entity name appears as a subsequence within an unrelated word. Maintaining per-language blocklists across many languages is operationally infeasible.

Regular-expression-based approaches improve on raw substring matching by enforcing word-boundary anchors. While effective for space-delimited Latin-script languages, such approaches fail for Chinese, Japanese, and Korean (CJK) scripts in which whitespace tokenization does not apply, and further fail for morphologically rich languages in which base words are concatenated with agglutinative suffixes that exceed any fixed tolerance window.

LLM-based classification offers contextual understanding but introduces latency on the order of one to five seconds per request and non-deterministic behavior that complicates compliance auditing and regression testing.

Prior hybrid approaches that inject named-entity-recognition (NER) features into a transformer through early fusion suffer from training instability caused by scale mismatch between learned high-dimensional representations and low-dimensional hand-crafted features, and yield marginal accuracy gains at the cost of pipeline complexity.

Accordingly, there is a need in the art for a multilingual entity mention detection system that simultaneously achieves a low false-positive rate suitable for enterprise compliance, native support for non-Latin scripts without substring-collision artifacts, sub-second inference latency at production scale, and a precision-biased error profile suitable for workflows in which false blocking disrupts user productivity.

### BRIEF SUMMARY OF THE DISCLOSURE

The present disclosure provides systems and methods for detecting entity mentions in multilingual text. In various embodiments, the disclosed systems and methods receive an item of text in any of a plurality of supported languages spanning a plurality of script families, together with a configured entity list, and produce a binary triggered-or-not-triggered determination indicating whether the item of text contains a mention of an entity drawn from the configured entity list.

In one embodiment, a system includes an input receiver, a named-entity-recognition (NER) feature extraction module, a transformer tokenizer, a neural inference module, a multi-guard post-filter chain module, and a result output. The NER feature extraction module produces an NER feature vector from the item of text and the configured entity list. The transformer tokenizer produces a tokenized representation of the item of text. The neural inference module includes a shared multilingual transformer encoder that produces a pooled representation from the tokenized representation, a late-fusion concatenation module that concatenates the pooled representation with the NER feature vector to form a joint representation after and external to encoder layers of the shared multilingual transformer encoder, and a classification head that produces an entity-mention probability from the joint representation. The multi-guard post-filter chain module compares the entity-mention probability to a configurable threshold and applies a plurality of sequential guards to produce a final decision.

In one aspect, the late-fusion concatenation is performed after and external to encoder layers of the shared multilingual transformer encoder, rather than by injection of the NER feature vector as additional input tokens, as bias terms within an attention mechanism, or as additional embedding dimensions at an input embedding layer. The late-fusion architecture avoids training instability arising from scale mismatch between learned high-dimensional representations of the shared multilingual transformer encoder and low-dimensional hand-crafted features of the NER feature vector, and supports parallel execution of the NER feature extraction module and the transformer tokenizer to reduce end-to-end inference latency.

In another aspect, the NER feature vector includes an exact-match feature, a fuzzy-similarity feature, an entity-overlap feature, an organization-entity feature, a position-score feature, and a mention-frequency feature, each normalized to a predetermined interval. The exact-match feature is computed by a Chinese-Japanese-Korean (CJK) aware substring matcher that performs case-folded substring containment testing without enforcement of whitespace word-boundary constraints in response to detecting CJK script characters in the item of text, thereby correctly capturing entity mentions in scripts that do not use whitespace-delimited tokenization.

In a further aspect, the multi-guard post-filter chain module includes, in order of increasing strictness, a first guard implementing lenient-substring matching, a second guard implementing word-boundary matching, a third guard implementing fuzzy-similarity matching with leetspeak rejection, and a fourth guard implementing all-capitals ticker-detection matching. A script family of the item of text is determined based on Unicode code-point ranges of characters in the item of text. In response to the script family being a non-Latin script family, at least one guard of the multi-guard post-filter chain module is short-circuited, and the final decision is produced based on the entity-mention probability exceeding the configurable threshold. The non-Latin script family includes one or more of Arabic, Chinese, Japanese, Korean, Devanagari, Greek, Hebrew, Cyrillic, and Thai scripts. The script-aware short-circuiting eliminates substring-collision false-positive artifacts that arise when matching heuristics tuned to whitespace-delimited Latin-script tokenization are applied to scripts that do not use whitespace-delimited tokenization, while preserving a contextual prediction produced by the shared multilingual transformer encoder for those scripts.

In a still further aspect, the multi-guard post-filter chain module further includes a business-context verification unit that maintains a configured lexicon of business-context indicator tokens and rejects a candidate entity mention identified by the multi-guard post-filter chain module in response to a context-verification result, based on proximity of the candidate entity mention to one or more business-context indicator tokens, being below a predetermined verification threshold.

In a still further aspect, the system is deployed as a serving deployment within a container orchestration platform, with one or more autoscaling replicas of the serving deployment scaling horizontally responsive to a request rate of an inbound traffic stream. Model artifacts for the system, including weights of the shared multilingual transformer encoder, a state dictionary of the classification head, and a plurality of per-language NER archives, are stored on a cloud object storage and loaded into each autoscaling replica at startup. The serving deployment supports sub-second end-to-end inference latency on the inbound traffic stream and produces deterministic output behavior in which an identical item of text produces an identical final decision across repeated invocations of the system.

The disclosed systems and methods are further implemented as a method performed by one or more processors and as a non-transitory computer-readable medium having stored thereon instructions which, when executed by one or more processors, cause the one or more processors to perform the operations described herein.

### BRIEF DESCRIPTION OF THE DRAWINGS

The present disclosure is illustrated and described with reference to the accompanying drawings, in which like reference numerals denote like elements throughout. The drawings are provided to facilitate understanding of exemplary embodiments and are not intended to limit the scope of the claims. Unless otherwise indicated, the drawings are not necessarily drawn to scale, and certain features may be enlarged, simplified, or schematically represented for clarity.

FIG. 1 is a diagram of a system for detecting entity mentions in multilingual text, including an input receiver, a named-entity-recognition (NER) feature extraction module, a transformer tokenizer, a neural inference module, a multi-guard post-filter chain module, and a result output, according to one embodiment of the present disclosure.

FIG. 2 is a diagram of internal structure of the neural inference module of FIG. 1, including an encoder path, an NER feature path, a late-fusion concatenation module, and a classification head, according to one embodiment of the present disclosure.

FIG. 3 is a diagram of internal structure of the multi-guard post-filter chain module of FIG. 1, including a pre-guard stage, a plurality of sequential guards, a script-aware bypass path, and a business-context verification unit, according to one embodiment of the present disclosure.

FIG. 4 is a bar chart of aggregate performance metrics of the system of FIG. 1 evaluated on a held-out multilingual evaluation corpus, according to one embodiment of the present disclosure.

FIG. 5 is a table of the aggregate performance metrics shown in FIG. 4, together with formulas defining each metric, according to one embodiment of the present disclosure.

FIG. 6 is a bar chart of a per-language accuracy distribution of the system of FIG. 1 across a plurality of target languages, according to one embodiment of the present disclosure.

FIG. 7 is a diagram of confusion matrices produced by the system of FIG. 1 for a representative target language of a first performance tier and a representative target language of a third performance tier, according to one embodiment of the present disclosure.

FIG. 8 is a bar chart of an ablation study quantifying a contribution of one or more architectural components of the system of FIG. 1 to aggregate performance metrics, according to one embodiment of the present disclosure.

FIG. 9 is a diagram of a production deployment architecture of the system of FIG. 1, including a container orchestration platform, a serving framework with one or more autoscaling replicas, a transformer encoder runtime, an NER engine runtime, and a cloud object storage, according to one embodiment of the present disclosure.

FIG. 10 is a block diagram of an example computing system that may be used to implement one or more components of the system of FIG. 1, according to one embodiment of the present disclosure.

### DETAILED DESCRIPTION OF THE DISCLOSURE

The present disclosure provides systems and methods for detecting entity mentions in multilingual text. In various embodiments, the disclosed systems and methods are deployed as an inline inspection layer that examines text generated by or transmitted through enterprise applications, including large language model (LLM) endpoints, chatbot platforms, content generation pipelines, internal knowledge assistants, and gateways for regulated-industry communications. The disclosed systems and methods determine, in real time and across a plurality of languages and script families, whether an item of text contains a mention of an entity drawn from a configured entity list, and return a binary triggered-or-not-triggered decision suitable for downstream policy enforcement, redaction, escalation, or audit logging.

At a high level, the disclosed architecture is made up of two parallel processing paths and a verification chain. A first path applies subword tokenization to the input text and produces a contextualized pooled representation through a shared multilingual transformer encoder. A second path, executable concurrently with the first path, applies named-entity-recognition (NER) processing to the input text together with the configured entity list, and produces a low-dimensional feature vector capturing exact-match, fuzzy-similarity, entity-overlap, organization-type, position, and mention-frequency signals. The contextualized pooled representation and the NER feature vector are concatenated by a late-fusion module to form a joint representation. The joint representation is provided to a multi-layer classification head that produces an entity-mention probability. A script-family detection unit examines the input text and conditionally engages a multi-guard post-filter chain, bypassing one or more guards in the chain for non-Latin script inputs.

The disclosed systems and methods address technical limitations of conventional content inspection. Keyword blocklists and regular-expression-based matching are computationally efficient but produce substring-collision false positives, fail on scripts without whitespace-delimited tokenization, and fail on morphologically rich languages in which suffix concatenation extends the matched token beyond a fixed tolerance window. LLM-based classification provides contextual understanding at latency on the order of one to five seconds per request, with non-deterministic behavior that complicates compliance auditing. Hybrid approaches that inject hand-crafted features into a transformer through early fusion exhibit training instability arising from scale mismatch between learned high-dimensional representations and low-dimensional hand-crafted features. The disclosed architecture addresses these limitations by deferring concatenation of the NER feature vector to a point after and external to encoder layers of the shared multilingual transformer encoder, thereby permitting parallel execution of the NER path and the transformer path, avoiding the scale-mismatch instability of early fusion, and reducing end-to-end latency.

The disclosed systems and methods further address a class of substring-collision artifacts that arise when Latin-centric heuristics are applied to non-Latin scripts. A script-family detection unit examines Unicode code-point ranges of the input text to determine whether the input belongs to a non-Latin script family, and, responsive to the determination, short-circuits one or more guards of the multi-guard post-filter chain. The disclosed bypass eliminates noisy heuristic interference on scripts that do not use whitespace-delimited tokenization, while preserving the contextual prediction produced by the shared multilingual transformer encoder for those scripts.

Use cases for the disclosed systems and methods include inline compliance inspection of LLM responses prior to delivery to an end user, pre-publication screening of multilingual marketing content produced by content generation pipelines, real-time inspection of responses produced by internal knowledge assistants, and policy enforcement on text traversing gateways for regulated industries including financial services, healthcare, defense, and government contracting. The disclosed entity-mention detection task subsumes competitor mention detection, brand mention detection for reputation monitoring, regulated-entity detection for financial compliance, sanctioned-party screening for export-control compliance, and personally-identifiable-information detection for privacy compliance.

The disclosed systems and methods provide several benefits and advantages relative to conventional content inspection. First, the late-fusion concatenation of a contextualized pooled representation with an NER feature vector provides the classification head with access to complementary information channels in a single forward pass, capturing both distributional semantics from the transformer encoder and discrete entity-level signals from the NER path. Second, the parallel execution of the NER feature extraction module and the transformer tokenizer eliminates serialization overhead that would otherwise be incurred by a strictly sequential pipeline. Third, the script-family-conditioned bypass of selected post-filter guards eliminates substring-collision false-positive artifacts on non-Latin scripts while preserving the contextual prediction of the shared multilingual transformer encoder. Fourth, the multi-guard post-filter chain, when fully engaged for Latin-script inputs, produces a precision-biased error profile suitable for enterprise compliance deployments in which false blocking disrupts user productivity. Fifth, the architecture is deterministic at inference time, supporting compliance auditing and regression testing in a manner that LLM-based classification does not.

### § 1.0 System Architecture

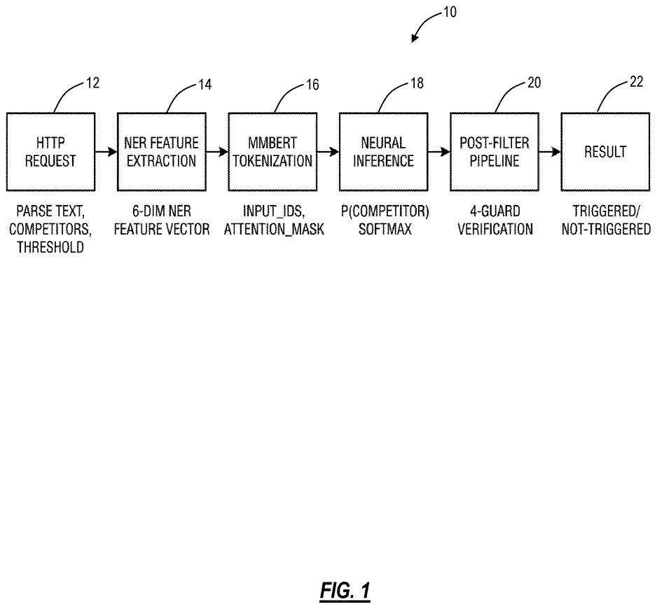

FIG. 1 is a diagram of a system 10 for detecting entity mentions in multilingual text according to one embodiment of the present disclosure. The system 10 includes an input receiver 12 that receives an item of text together with a configured entity list and a configurable threshold; a named-entity-recognition (NER) feature extraction module 14 that produces an NER feature vector from the item of text and the configured entity list; a transformer tokenizer 16 that applies subword tokenization to the item of text to produce a tokenized representation; a neural inference module 18 that produces an entity-mention probability from the NER feature vector and the tokenized representation; a multi-guard post-filter chain module 20 that produces a verified decision from the entity-mention probability and the item of text; and a result output 22 that returns the verified decision indicating whether the item of text is triggered or not-triggered.

The input receiver 12 accepts the item of text in any of a plurality of supported languages, the configured entity list specifying one or more entity names of interest, and the configurable threshold against which the entity-mention probability is compared. In one embodiment, the input receiver 12 is implemented as a Hypertext Transfer Protocol (HTTP) request handler that parses an inbound request body to extract the item of text, the configured entity list, and the configurable threshold. The configurable threshold supports per-policy configuration such that different deployments may apply different sensitivity levels without retraining the system 10.

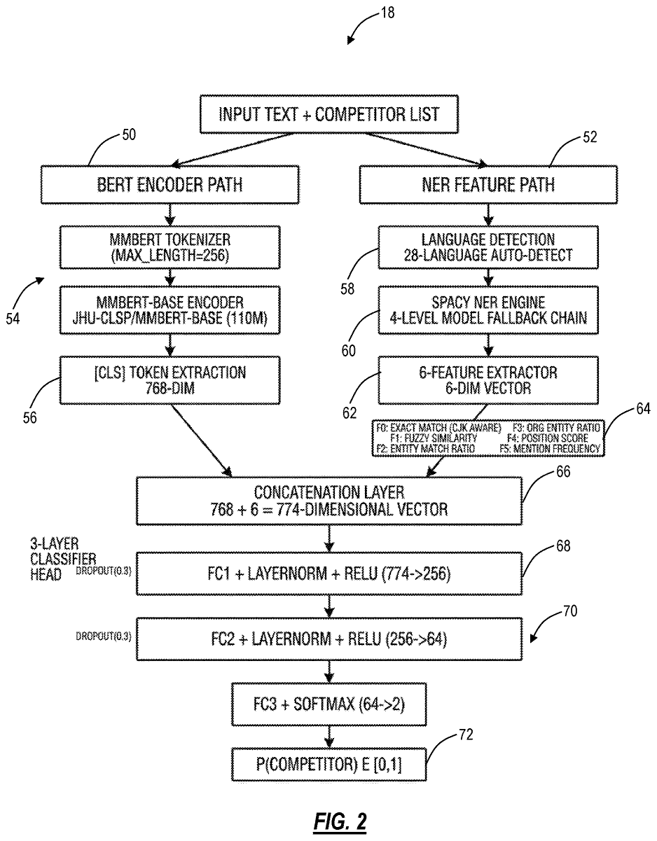

The NER feature extraction module 14 processes the item of text and the configured entity list to produce the NER feature vector. In the embodiment of FIG. 1, the NER feature vector is a low-dimensional vector whose components capture exact-match, fuzzy-similarity, entity-overlap, organization-type, position, and mention-frequency signals, each component normalized to the interval zero to one. The composition and computation of the NER feature vector are described in further detail with reference to FIG. 2.

The transformer tokenizer 16 applies subword tokenization to the item of text to produce the tokenized representation. In one embodiment, the tokenized representation includes a sequence of input token identifiers and an attention mask, the sequence having a maximum length parameter of two-hundred-fifty-six tokens in an embodiment.

The neural inference module 18 receives the NER feature vector and the tokenized representation and produces the entity-mention probability. The neural inference module 18 includes a shared multilingual transformer encoder, a late-fusion concatenation module, and a classification head, the internal structure of which is described in further detail with reference to FIG. 2. The entity-mention probability takes a value in the interval zero to one, produced in one embodiment by a softmax normalization at an output layer of the classification head.

The multi-guard post-filter chain module 20 receives the entity-mention probability and the item of text and produces the verified decision. The multi-guard post-filter chain module 20 includes a script-family detection unit and a plurality of sequential guards, the structure and operation of which are described in further detail with reference to FIG. 4. The verified decision indicates whether the item of text is to be reported as triggered or not-triggered for downstream policy enforcement, redaction, escalation, or audit logging.

The result output 22 returns the verified decision to a calling process or a downstream consumer. In one embodiment, the result output 22 returns the verified decision in a response to the HTTP request received by the input receiver 12, the response indicating triggered or not-triggered status for the item of text.

Although FIG. 1 illustrates the NER feature extraction module 14 and the transformer tokenizer 16 in a sequential arrangement for clarity of illustration, in one embodiment the NER feature extraction module 14 and the transformer tokenizer 16 execute on independent code paths and are dispatched concurrently, such that the NER feature vector is available no later than completion of subword tokenization by the transformer tokenizer 16. The concurrent execution eliminates serialization overhead that would otherwise be incurred by a strictly sequential pipeline and reduces end-to-end inference latency. In one production embodiment, the processing stages of the system 10 complete in approximately three-hundred-fifty milliseconds at the 95th percentile on a deployment configured with autoscaling replicas.

The system 10 provides a modular boundary between the neural inference module 18 and the multi-guard post-filter chain module 20. The neural inference module 18 captures contextual semantics of the item of text via the shared multilingual transformer encoder. The multi-guard post-filter chain module 20 applies deterministic verification of entity-name presence under script-appropriate matching conditions. The modular boundary supports independent optimization, update, and replacement of the neural inference module 18 and the multi-guard post-filter chain module 20, including retraining of the neural inference module 18 without modification of the multi-guard post-filter chain module 20, and update of the multi-guard post-filter chain module 20 without retraining of the neural inference module 18.

### § 1.1 Shared Multilingual Transformer Encoder and Late Fusion

FIG. 2 is a diagram of internal structure of the neural inference module 18 of FIG. 1 according to one embodiment. The neural inference module 18 includes an encoder path 50 and a named-entity-recognition (NER) feature path 52 operating in parallel on the item of text. The encoder path 50 includes the transformer tokenizer 16 and a shared multilingual transformer encoder 54 that produces a pooled representation 56. The NER feature path 52 corresponds to the NER feature extraction module 14 of FIG. 1 and includes a language detection unit 58, an NER engine 60, and a feature computation unit 62 that together produce an NER feature vector 64 from the item of text and the configured entity list. A late-fusion concatenation module 66 receives the pooled representation 56 and the NER feature vector 64 and produces a joint representation 68. A classification head 70 receives the joint representation 68 and produces an entity-mention probability 72.

The shared multilingual transformer encoder 54 is pretrained on a multilingual corpus spanning a plurality of languages and a plurality of script families. In an embodiment, the shared multilingual transformer encoder 54 is implemented as an mmBERT-base transformer having a hidden dimension of 768 and a SentencePiece subword vocabulary providing native coverage for at least 28 target languages spanning at least 7 script families including Latin, Cyrillic, Arabic, Hebrew, Devanagari, Thai, Greek, and Chinese-Japanese-Korean (CJK) scripts. In other embodiments, the shared multilingual transformer encoder 54 is implemented as a different multilingual transformer architecture, including but not limited to mBERT, XLM-RoBERTa, or a distilled or quantized variant thereof.

The shared multilingual transformer encoder 54 receives the tokenized representation produced by the transformer tokenizer 16 and produces a sequence of contextualized token embeddings. A pooling operation extracts a contextualized representation at a predetermined token position of the sequence to form the pooled representation 56. In one embodiment, the pooling operation extracts an embedding of a classification token at position zero of the sequence, the classification token being a [CLS] token prepended to the tokenized representation by the transformer tokenizer 16. In other embodiments, the pooling operation is implemented as mean pooling, max pooling, or attention-weighted pooling across the sequence of contextualized token embeddings. The pooled representation 56 has a dimension equal to the hidden dimension of the shared multilingual transformer encoder 54, which is 768 in an embodiment.

The NER feature path 52 of FIG. 2 corresponds to the NER feature extraction module 14 of FIG. 1. In summary, the language detection unit 58 produces a detected language code from the item of text. The NER engine 60 is configured with a model selected based on the detected language code, and produces a set of entity spans from the item of text. The feature computation unit 62 produces the NER feature vector 64 from the entity spans, the item of text, and the configured entity list. In an embodiment, the NER feature vector 64 has a dimension of 6, with each component normalized to the interval [0, 1]. The 6 components of the NER feature vector 64 capture exact-match, fuzzy-similarity, entity-overlap, organization-type, position-score, and mention-frequency signals, designated F0 through F5 in FIG. 2.

The late-fusion concatenation module 66 concatenates the pooled representation 56 with the NER feature vector 64 to form the joint representation 68. The joint representation 68 has a dimension equal to the sum of the dimension of the pooled representation 56 and the dimension of the NER feature vector 64. In an embodiment of FIG. 2, the joint representation 68 has a dimension of 774, formed by concatenation of a 768-dimensional pooled representation 56 with a 6-dimensional NER feature vector 64.

A feature of the present disclosure is that the concatenation performed by the late-fusion concatenation module 66 is applied after and external to encoder layers of the shared multilingual transformer encoder 54, rather than by injection of the NER feature vector 64 as additional input tokens, as bias terms within an attention mechanism of the shared multilingual transformer encoder 54, or as additional embedding dimensions concatenated at an input embedding layer of the shared multilingual transformer encoder 54. It has been empirically determined that early fusion, in which a hand-crafted feature vector is injected into a transformer at an embedding layer or as an attention bias, introduces training instability arising from scale mismatch between learned high-dimensional representations of the shared multilingual transformer encoder 54, whose values typically lie in a range on the order of ±2, and low-dimensional hand-crafted features of the NER feature vector 64, each of which is normalized to the interval [0, 1]. The late-fusion architecture of FIG. 2 avoids the scale-mismatch instability by deferring concatenation until after a forward pass of the shared multilingual transformer encoder 54, and additionally permits the NER feature path 52 to execute concurrently with the encoder path 50, as described above in connection with FIG. 1.

The classification head 70 receives the joint representation 68 and produces the entity-mention probability 72. In an embodiment, the classification head 70 is a three-layer fully-connected network. A first layer of the classification head 70 projects from a first dimension equal to the dimension of the joint representation 68 to a second dimension, followed by layer normalization, a rectified linear unit (ReLU) activation, and dropout regularization. A second layer of the classification head 70 projects from the second dimension to a third dimension, followed by layer normalization, ReLU activation, and dropout regularization. A third layer of the classification head 70 projects from the third dimension to two output classes, followed by softmax normalization. In the embodiment of FIG. 2, the first dimension is 774, the second dimension is 256, the third dimension is 64, and the dropout regularization is applied at a probability of 0.3. The entity-mention probability 72 takes a value in the interval [0, 1], the value representing a probability that the item of text contains a mention of an entity drawn from the configured entity list.

In other embodiments, the classification head 70 has a different number of fully-connected layers, different intermediate dimensions, different normalization layers, different activation functions, or a different output layer producing the entity-mention probability 72. The selection of three layers, layer normalization, ReLU activation, dropout at probability 0.3, and softmax normalization in an embodiment reflects an empirical balance between representational capacity and overfitting under a training corpus used to train the classification head 70.

### § 1.2 Named-Entity-Recognition Feature Extraction Module

The NER feature extraction module 14, introduced above in connection with FIG. 1 and shown in further detail as the NER feature path 52 of FIG. 2, produces the NER feature vector 64 from the item of text and the configured entity list. The NER feature extraction module 14 includes the language detection unit 58, the NER engine 60, and the feature computation unit 62. The NER feature vector 64 has, in an embodiment, a dimension of 6, and includes six components designated F0 through F5 referenced herein as an exact-match feature F0, a fuzzy-similarity feature F1, an entity-overlap feature F2, an organization-entity feature F3, a position-score feature F4, and a mention-frequency feature F5. Each component is normalized to the interval [0, 1].

The language detection unit 58 receives the item of text and produces a detected language code identifying one of a plurality of supported languages. In an embodiment, the language detection unit 58 is implemented as a lingua-py language identifier configured to discriminate among at least 28 target languages. In other embodiments, the language detection unit 58 is implemented as a fastText language identifier, a Compact Language Detector (CLD3) language identifier, or another language identification model. The detected language code is provided to the NER engine 60 to select an appropriate NER model for the item of text.

The NER engine 60 receives the item of text and the detected language code and produces a set of entity spans, each entity span specifying a character range within the item of text, an entity type label, and a confidence score. In an embodiment, the NER engine 60 is implemented using spaCy and is configured with a multi-level model fallback chain that selects an NER model based on the detected language code. The model fallback chain selects, in order: (i) a dedicated per-language spaCy archive when one is available for the detected language code, (ii) a multilingual cross-lingual entity model when no dedicated per-language archive is available for the detected language code, (iii) a default model providing a baseline entity recognition capability when neither a dedicated per-language archive nor the multilingual cross-lingual entity model is loadable, and (iv) a graceful degradation mode in which the NER engine 60 returns an empty set of entity spans and the feature computation unit 62 relies on the exact-match feature F0 and the fuzzy-similarity feature F1 alone. In an embodiment, the model fallback chain includes 17 dedicated per-language spaCy archives.

The feature computation unit 62 receives the entity spans produced by the NER engine 60, the item of text, and the configured entity list, and produces the NER feature vector 64. The six components of the NER feature vector 64 are computed as follows.

The exact-match feature F0 is computed as a binary or graded indication of whether at least one entity name in the configured entity list appears as a substring of the item of text under a case-folded comparison. In an embodiment, the exact-match feature F0is computed by a CJK-aware substring matcher that performs case-folded substring containment testing without enforcement of whitespace word-boundary constraints. The CJK-aware substring matcher determines, based on Unicode code-point ranges of characters in the item of text, whether the item of text contains characters drawn from a CJK script family including Chinese, Japanese, or Korean, and, in response to such determination, performs the substring containment testing without whitespace word-boundary anchors. The CJK-aware substring matcher thereby correctly captures entity mentions in scripts that do not use whitespace-delimited tokenization, in which a regular-expression word-boundary anchor would erroneously reject a valid mention.

The fuzzy-similarity feature F1 is computed as a normalized similarity score between at least one entity name in the configured entity list and a substring of the item of text. In an embodiment, the fuzzy-similarity feature F1 is computed by a rapidfuzz ratio function applied between each entity name and a length-gated sliding window of the item of text, with a maximum taken across all sliding-window positions and all entity names. The length gating restricts the sliding window to a length within a predetermined factor of the length of the entity name being compared, thereby preventing pathological matches between a short entity name and a long unrelated text span that would otherwise share a high character-level similarity score due to substring overlap.

The entity-overlap feature F2 is computed as a ratio of entity spans, produced by the NER engine 60, whose extracted entity text matches an entity name in the configured entity list, to a total count of entity spans produced by the NER engine 60. The matching is performed under a case-folded comparison and, in an embodiment, also applies the CJK-aware substring containment logic described above for the exact-match feature F0.

The organization-entity feature F3 is computed identically to the entity-overlap feature F2 with the additional restriction that only entity spans having an entity type label corresponding to an organization are considered. In an embodiment, the entity type label corresponding to an organization is the spaCy ORG label, and in additional embodiments includes related entity type labels such as PRODUCT and GPE (geopolitical entity). The organization-entity feature F3 reflects the empirical observation that entity names of interest in competitor-mention detection and related entity-mention detection tasks are predominantly organization-type entities.

The position-score feature F4 is computed as one minus a ratio of a character position of a first occurrence of an entity name from the configured entity list within the item of text, to a total character length of the item of text. The position-score feature F4 reflects the observation that early mentions of an entity within a text item are more salient indicators of the topical focus of the text item than later mentions, and that an entity mentioned in the opening of a text item is more likely to be the subject of the text item than an entity mentioned only in the closing.

The mention-frequency feature F5 is computed as a count of occurrences of entity names from the configured entity list within the item of text, divided by a total count of entity spans produced by the NER engine 60, with a saturation applied at a predetermined maximum value. In an embodiment, the saturation is applied such that the mention-frequency feature F5 attains a value of 1.0 when the count of occurrences reaches a saturation count of 3. The saturation prevents the feature from being dominated by outlier counts in long text items containing many mentions of a single entity.

All six components of the NER feature vector 64 are normalized to the interval [0, 1] prior to concatenation by the late-fusion concatenation module 66. The normalization ensures that no single component of the NER feature vector 64 dominates the joint representation 68 due to differences in magnitude scale, and produces a consistent input distribution for the classification head 70.

In one embodiment, the NER feature extraction module 14 executes on a code path independent of the encoder path 50, such that the language detection unit 58, the NER engine 60, and the feature computation unit 62 process the item of text concurrently with subword tokenization by the transformer tokenizer 16 and forward-pass computation by the shared multilingual transformer encoder 54. The concurrent execution model permits the NER feature vector 64 to be available no later than completion of the forward pass of the shared multilingual transformer encoder 54, and supports the production-deployment latency characteristics described above in connection with FIG. 1.

### § 1.3 Script-Aware Multi-guard Post-Filter Chain

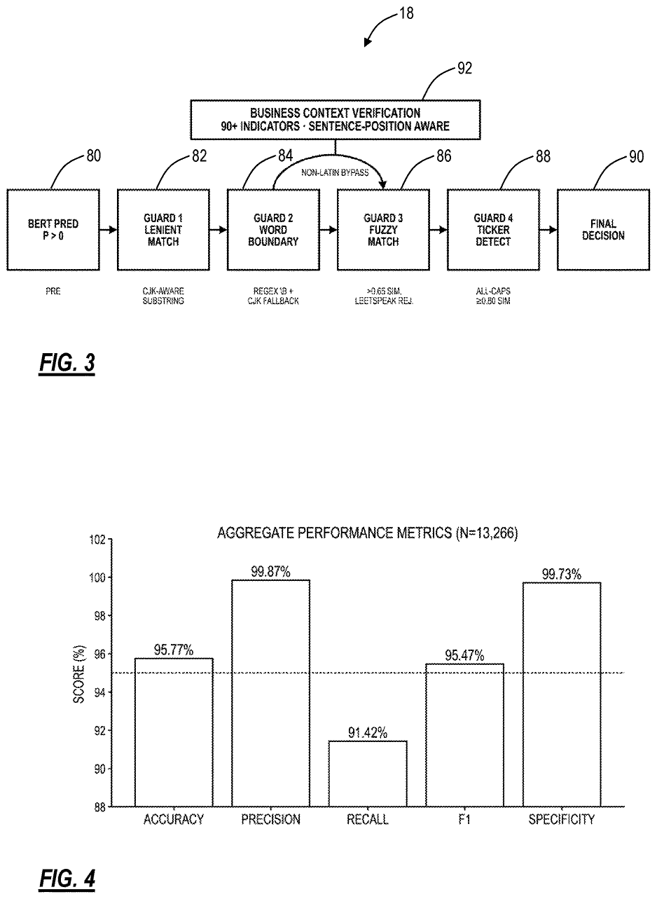

FIG. 3 is a diagram of internal structure of the multi-guard post-filter chain module 20 of FIG. 1 according to one embodiment. The multi-guard post-filter chain module 20 includes a pre-guard stage 80 that receives the entity-mention probability 72 from the neural inference module 18, a plurality of sequential guards arranged in order of increasing strictness, and a business-context verification unit 92 that operates in conjunction with the plurality of sequential guards. The plurality of sequential guards includes a first guard 82, a second guard 84, a third guard 86, and a fourth guard 88. The multi-guard post-filter chain module 20 produces a final decision 90 indicating whether the item of text is to be reported as triggered or not-triggered.

The pre-guard stage 80 receives the entity-mention probability 72 and the configurable threshold and admits candidates having an entity-mention probability 72 exceeding the configurable threshold. In an embodiment, the configurable threshold takes a value of 0.70, although the value is selectable on a per-policy basis as described above in connection with the input receiver 12 of FIG. 1. Candidates failing the pre-guard stage 80 are reported as not-triggered by the final decision 90 without further processing. Candidates passing the pre-guard stage 80 proceed to the plurality of sequential guards, subject to conditional bypass as described below.

The first guard 82 is a lenient-substring guard that performs case-folded substring containment testing of an entity name from the configured entity list against the item of text. In an embodiment, the first guard 82 is configured to perform exact substring matching for items of text containing CJK script characters and word-aware substring matching for items of text in Latin-script languages. The first guard 82 applies a suffix tolerance window that allows a candidate entity mention to be matched even when the entity name in the item of text is followed by a small number of additional characters representing inflectional morphology. In an embodiment, the suffix tolerance window admits up to two additional characters following the entity name.

The second guard 84 is a word-boundary guard that performs regular-expression matching using word-boundary anchors. In an embodiment, the second guard 84 applies a strict regular-expression word-boundary anchor (the \b token) for items of text in Latin-script languages, and falls back to the lenient-substring behavior of the first guard 82 for items of text containing CJK script characters. The second guard 84 thereby rejects partial-token matches that would otherwise pass the first guard 82, including substring-collision false positives in which an entity name appears as a non-bounded subsequence within an unrelated word.

The third guard 86 is a fuzzy-similarity guard that applies a normalized similarity comparison between the entity name and a token of the item of text. In an embodiment, the third guard 86 applies a rapidfuzz ratio comparison at a similarity threshold of 0.65, with leetspeak rejection implemented via character-class normalization that maps digit-for-letter substitutions to canonical alphabetic forms prior to comparison. The leetspeak rejection rejects candidates in which one or more characters of the entity name have been substituted with visually similar digit characters in an apparent attempt to evade detection.

The fourth guard 88 is an all-capitals ticker-detection guard that applies a similarity comparison between the entity name and a token of the item of text restricted to tokens composed entirely of uppercase alphabetic characters. In an embodiment, the fourth guard 88 applies a similarity threshold of 0.80 to all-capital tokens having a length between 3 and 5 characters, thereby disambiguating stock-ticker symbol references from common-word false matches. Tokens failing the all-capitals condition or the length condition are passed without further evaluation by the fourth guard 88.

A feature of the present disclosure is a script-aware bypass path through the multi-guard post-filter chain module 20. A script-family of the item of text is determined based on Unicode code-point ranges of characters in the item of text. In response to the script-family identifying a non-Latin script family, the multi-guard post-filter chain module 20 short-circuits the second guard 84, the third guard 86, and the fourth guard 88, and produces the final decision 90 based on the entity-mention probability 72 having passed the pre-guard stage 80 without application of the second, third, and fourth guards. In an embodiment, the non-Latin script family includes one or more of Arabic script, Chinese script, Japanese script, Korean script, Devanagari script, Greek script, Hebrew script, Cyrillic script, and Thai script. In one embodiment, the script-family determination is performed by a script-family detection unit implemented within the multi-guard post-filter chain module 20. In another embodiment, the script-family determination is performed externally to the multi-guard post-filter chain module 20 and the resulting script-family label is provided as an input to the multi-guard post-filter chain module 20.

The script-aware bypass addresses an empirical observation that non-Latin scripts do not exhibit the substring-collision problem that motivates the second guard 84, the third guard 86, and the fourth guard 88. The second, third, and fourth guards apply matching heuristics that are tuned to whitespace-delimited Latin-script tokenization, and application of these heuristics to non-Latin scripts introduces noise rather than signal, eliminating valid entity mentions that the neural inference module 18 has correctly identified. By short-circuiting the second, third, and fourth guards for non-Latin script inputs, the disclosed multi-guard post-filter chain module 20 preserves the contextual prediction of the shared multilingual transformer encoder 54 for non-Latin scripts while applying the full guard chain to Latin-script inputs that benefit from substring-collision suppression.

The business-context verification unit 92 receives a candidate entity mention identified by one or more of the plurality of sequential guards and produces a context-verification result that conditions admission of the candidate by the final decision 90. In an embodiment, the business-context verification unit 92 maintains a lexicon of business-context indicator tokens and computes a sentence-position-aware score that rewards a candidate entity mention appearing within a predetermined token-distance window of one or more business-context indicator tokens, and penalizes a candidate entity mention appearing in isolation from any business-context indicator token within the sentence containing the candidate. In an embodiment, the lexicon includes at least 90 business-context indicator tokens. Candidates having a context-verification result below a predetermined verification threshold are rejected, and the final decision 90 reports the item of text as not-triggered notwithstanding passage of the plurality of sequential guards. The business-context verification unit 92 thereby suppresses false positives arising from entity names that appear in non-business contexts, including entity names that are also common nouns in the supported languages.

The final decision 90 is produced from the output of the plurality of sequential guards, the script-aware bypass, and the business-context verification unit 92. The final decision 90 reports the item of text as triggered when (i) the entity-mention probability 72 exceeds the configurable threshold at the pre-guard stage 80, (ii) one of the script-aware bypass is activated for a non-Latin script input or the plurality of sequential guards is fully passed for a Latin-script input, and (iii) the business-context verification unit 92 produces a context-verification result at or above the predetermined verification threshold for a candidate entity mention. The final decision 90 reports the item of text as not-triggered in all other cases.

The plurality of sequential guards is arranged in order of increasing strictness, such that a candidate entity mention passing all four guards has a higher likelihood of being a true mention than a candidate entity mention passing only the first guard 82. The ordering reflects an empirical balance between recall and precision: the first guard 82 admits inflectional variants and morphological forms that increase recall, while the second guard 84, the third guard 86, and the fourth guard 88 progressively eliminate substring-collision, leetspeak-substitution, and ticker-confusion false-positive modes. In an embodiment, removal of all four guards from the multi-guard post-filter chain module 20 has been empirically observed to increase a false-positive rate by a factor of approximately 5.2 relative to the configuration of FIG. 3, with only a marginal corresponding improvement in recall.

### § 2.0 Aggregate Evaluation Performance

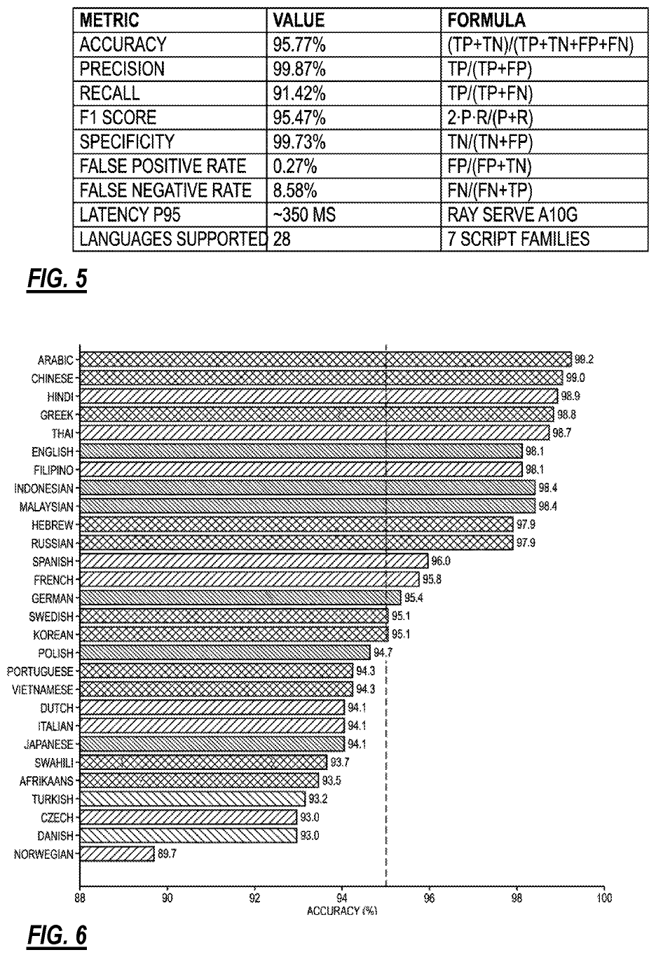

FIG. 4 is a bar chart of aggregate performance metrics of the system 10 according to one embodiment, evaluated on a held-out multilingual evaluation corpus. FIG. 5 is a table of the aggregate performance metrics shown in FIG. 4, together with formulas defining each metric, presented in tabular form.

An evaluation of one embodiment of the system 10 was conducted on a held-out evaluation corpus including 13,266 text samples balanced across 28 target languages spanning 7 script families. The 7 script families include Latin, Cyrillic, Arabic, Hebrew, Devanagari, Thai, and Chinese-Japanese-Korean (CJK) scripts. The evaluation corpus includes positive samples in which an entity name from a configured entity list appears in a business context within the text sample, and negative samples in which no entity name from the configured entity list appears in the text sample or the entity name appears in a non-business context. The negative samples include adversarial subcategories selected to exercise the substring-collision, common-word, and capitalization-artifact false-positive modes that the multi-guard post-filter chain module 20 is configured to suppress.

Referring to FIG. 4 and FIG. 5, the system 10 produces, on the evaluation corpus, an accuracy of 95.77 percent, a precision of 99.87 percent, a recall of 91.42 percent, an F 1 score of 95.47 percent, and a specificity of 99.73 percent. A false-positive rate is 0.27 percent and a false-negative rate is 8.58 percent. A confusion matrix produced by the system 10 on the evaluation corpus includes 17 false-positive samples and 596 false-negative samples, producing a ratio of false-negative samples to false-positive samples of approximately 35 to 1.

Each metric reported in FIG. 4 and FIG. 5 is computed from a count of true-positive samples, denoted TP, a count of true-negative samples, denoted TN, a count of false-positive samples, denoted FP, and a count of false-negative samples, denoted FN. The accuracy is computed as a sum of TP and TN divided by a sum of TP, TN, FP, and FN. The precision is computed as TP divided by a sum of TP and FP. The recall is computed as TP divided by a sum of TP and FN. The F1 score is computed as twice the product of precision and recall divided by a sum of precision and recall. The specificity is computed as TN divided by a sum of TN and FP. The false-positive rate is computed as FP divided by a sum of FP and TN. The false-negative rate is computed as FN divided by a sum of FN and TP.

The aggregate performance metrics of FIG. 4 and FIG. 5 reflect a precision-biased operating point of the system 10. The ratio of false-negative samples to false-positive samples of approximately 35 to 1 indicates that the configurable threshold of the pre-guard stage 80, set to 0.70 in the embodiment described above in connection with FIG. 3, produces a decision boundary positioned to suppress false positives at the expense of recall. The precision-biased operating point is appropriate for enterprise compliance deployments of the system 10, in which a false-positive determination causes a legitimate item of text to be blocked or flagged, disrupting user productivity, while a false-negative determination causes an entity mention to remain undetected by the system 10 but does not directly disrupt user productivity.

The false-positive rate of 0.27 percent indicates that fewer than 3 in 1,000 items of text not containing an entity mention are incorrectly reported as triggered by the system 10. The specificity of 99.73 percent indicates the complementary observation that more than 997 in 1,000 items of text not containing an entity mention are correctly reported as not-triggered.

In one production embodiment, the system 10 produces the aggregate performance metrics of FIG. 4 and FIG. 5 at a 95th-percentile end-to-end inference latency of approximately 350 milliseconds, measured on a deployment configured with autoscaling replicas as described above in connection with FIG. 1. The combination of the aggregate performance metrics and the production latency characteristics occupies a region of the accuracy-precision-latency design space that is not occupied by conventional keyword blocklist, regular-expression-based, or large language model based entity-mention-detection approaches, each of which exhibits a deficiency in at least one of accuracy, precision, latency, or supported language coverage as described above.

### § 2.1 Per-Language Analysis and Language Tier Classification

FIG. 6 is a bar chart of a per-language accuracy distribution of the system 10 according to one embodiment, evaluated on the held-out multilingual evaluation corpus described above in connection with FIG. 4 and FIG. 5. The per-language accuracy distribution reports an accuracy of the system 10 separately for each of the 28 target languages, with each bar corresponding to one target language and a length of each bar representing the accuracy of the system 10 on a subset of the evaluation corpus restricted to that target language.

Referring to FIG. 6, the per-language accuracy of the system 10 ranges from approximately 89.7 percent for a lowest-performing target language to approximately 99.2 percent for a highest-performing target language. A stratification of the per-language accuracy by script family of the target language is observed. Target languages employing non-Latin scripts, including Arabic, Chinese, Hindi, Greek, and Thai, cluster at accuracies at or above approximately 98 percent. Target languages employing Latin script and exhibiting morphologically rich agglutinative or compound-word formation, including Norwegian, Danish, Czech, Turkish, and Afrikaans, cluster at accuracies in the range of approximately 89 percent to 94 percent. Target languages employing Latin script without significant agglutinative morphology cluster at intermediate accuracies in the range of approximately 94 percent to 98 percent.

The stratification observed in FIG. 6 reflects the operation of the script-aware bypass described above in connection with FIG. 3. Target languages employing non-Latin scripts activate the script-aware bypass and produce the final decision 90 based on the entity-mention probability 72 having passed the pre-guard stage 80, without application of the second guard 84, the third guard 86, and the fourth guard 88. Target languages employing Latin script activate the full plurality of sequential guards. The stratification thereby directly reflects the effectiveness of the script-aware bypass at preserving the contextual prediction of the shared multilingual transformer encoder 54 for non-Latin script inputs while applying substring-collision suppression to Latin-script inputs for which substring-collision is a dominant false-positive mode.

The target languages of FIG. 6 cluster into three performance tiers based on the per-language accuracy and an engagement level of the multi-guard post-filter chain module 20. A first performance tier of the target languages is characterized by a per-language accuracy at or above approximately 98 percent and activation of the script-aware bypass through the multi-guard post-filter chain module 20. In one embodiment, the first performance tier includes Arabic, Chinese, Hindi, Greek, Thai, English, and Filipino. The inclusion of English and Filipino in the first performance tier, notwithstanding that English and Filipino employ Latin script, reflects a sufficiency of the shared multilingual transformer encoder 54 and the full plurality of sequential guards to suppress false positives in these target languages to a level comparable to the non-Latin script target languages.

A second performance tier of the target languages is characterized by a per-language accuracy in a range of approximately 95 percent to 98 percent and activation of the full plurality of sequential guards. In one embodiment, the second performance tier includes Hebrew, Russian, Indonesian, Malaysian, Spanish, and French. Target languages in the second performance tier exhibit Latin-script or partially-Latin-script tokenization for which the second guard 84, the third guard 86, and the fourth guard 88 of FIG. 3 operate effectively, and exhibit limited agglutinative or compound-word formation.

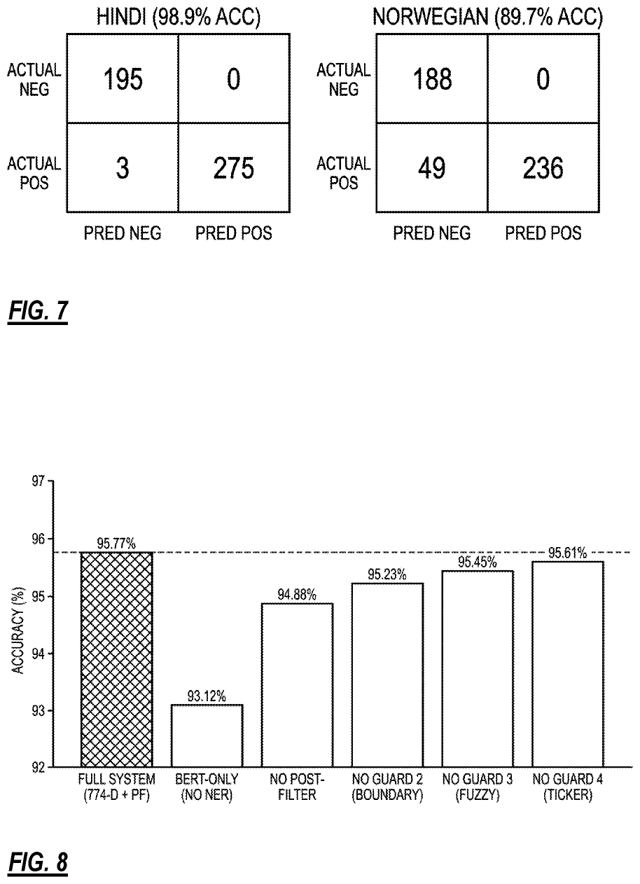

A third performance tier of the target languages is characterized by a per-language accuracy below approximately 95 percent and activation of the full plurality of sequential guards, with a morphological bottleneck arising from agglutinative suffix patterns or compound-word formation exceeding a suffix tolerance window of the first guard 82. In one embodiment, the third performance tier includes Norwegian, Danish, Czech, Turkish, Afrikaans, Polish, Portuguese, Vietnamese, Dutch, Italian, Japanese, Korean, Swedish, German, and Swahili. The morphological bottleneck is described in further detail below in connection with the false-negative analysis of FIG. 7.

The morphological bottleneck of the third performance tier arises from a mechanism in which an entity name from the configured entity list is concatenated within a single orthographic token of an item of text with one or more inflectional or derivational suffixes specific to the target language, producing a concatenated token having a length exceeding the suffix tolerance window admitted by the first guard 82. In one example, a Norwegian item of text concatenates an entity name with a Norwegian noun suffix to produce a single concatenated token, which fails a word-boundary check of the second guard 84 and produces a false-negative determination notwithstanding a correct prediction of the entity-mention probability 72 by the neural inference module 18.

The performance tier classification of the target languages, derived from the per-language accuracy distribution of FIG. 6, supports per-policy threshold configuration of the configurable threshold at the pre-guard stage 80 of the multi-guard post-filter chain module 20. In one embodiment, the configurable threshold is set to a lower value for target languages in the third performance tier than for target languages in the first performance tier and the second performance tier, to partially recover recall on the target languages exhibiting the morphological bottleneck while accepting a corresponding increase in false-positive rate.

### § 2.2 Error Analysis and Confusion Matrices

FIG. 7 is a diagram of two confusion matrices produced by the system 10 according to one embodiment, evaluated on the held-out multilingual evaluation corpus described above in connection with FIG. 4 and FIG. 5. A first confusion matrix of FIG. 7 corresponds to a target language in the first performance tier described above in connection with FIG. 6, and a second confusion matrix of FIG. 7 corresponds to a target language in the third performance tier described above in connection with FIG. 6. Each confusion matrix reports a count of true-positive samples, a count of true-negative samples, a count of false-positive samples, and a count of false-negative samples produced by the system 10 on a subset of the evaluation corpus restricted to the corresponding target language.

Referring to FIG. 7, the first confusion matrix corresponds to Hindi, a representative target language of the first performance tier characterized by activation of the script-aware bypass through the multi-guard post-filter chain module 20. The first confusion matrix reports a per-language accuracy of approximately 98.9 percent, with a small count of false-negative samples and a count of false-positive samples of zero. The second confusion matrix corresponds to Norwegian, a representative target language of the third performance tier characterized by full activation of the plurality of sequential guards and a morphological bottleneck arising from compound-word formation. The second confusion matrix reports a per-language accuracy of approximately 89.7 percent, with a count of false-negative samples of approximately 49 and a count of false-positive samples of zero.

The contrast between the first confusion matrix and the second confusion matrix of FIG. 7 illustrates two characteristics of the error profile of the system 10. A first characteristic is that the count of false-positive samples is near zero or zero across both performance tiers, reflecting the precision-biased operating point of the system 10 at the configurable threshold of 0.70 disclosed above in connection with FIG. 3. A second characteristic is that the count of false-negative samples is substantially higher for target languages in the third performance tier than for target languages in the first performance tier, reflecting the morphological bottleneck described above in connection with FIG. 6.

The system 10 produces, on the evaluation corpus as a whole, a heavily precision-biased error profile of approximately 596 false-negative samples and 17 false-positive samples, as reported above in connection with FIG. 4 and FIG. 5. The ratio of false-negative samples to false-positive samples of approximately 35 to 1 reflects the conservative decision boundary at the configurable threshold of 0.70, and reflects an empirical balance appropriate for enterprise compliance deployments in which a false-positive determination disrupts user productivity.

A false-negative analysis of the third performance tier of FIG. 6, performed by inspection of a subset of false-negative samples produced by the system 10 on Norwegian target language samples, identified four mechanisms of false-negative formation. A first mechanism is concatenation of an entity name with a genitive or possessive suffix specific to the target language, producing a concatenated token failing a word-boundary check of the second guard 84. A second mechanism is compound-word formation, in which the entity name forms a first element of a compound word and a second element is concatenated to the entity name without an intervening whitespace character. A third mechanism is concatenation of an entity name with a definite article suffix or other postpositional grammatical marker specific to the target language. A fourth mechanism is derivational morphology, in which the entity name is suffixed with a derivational ending forming a derived noun, adjective, or verb form.

A false-positive analysis of the false-positive samples produced by the system 10 on the evaluation corpus identified three categories of false-positive formation. A first category includes ticker-like acronyms in the item of text that pass a similarity threshold of the fourth guard 88 despite referring to a non-entity concept. A second category includes loanwords in the target language that retain the orthography of an entity name from the configured entity list while referring to a non-entity concept. A third category includes edge cases in which the exact-match component of the NER feature vector 64 produced by the feature computation unit 62 dominates the joint representation 68 and overrides a contextual disambiguation that would otherwise have been provided by the shared multilingual transformer encoder 54.

The low aggregate count of false-positive samples, at 17 samples across the 13,266-sample evaluation corpus, validates an effectiveness of the multi-guard post-filter chain module 20 in suppressing false alarms across the categories of false-positive formation identified by the false-positive analysis, while preserving a recall level produced by the neural inference module 18 in isolation.

### § 2.3 Ablation Study

FIG. 8 is a bar chart of an ablation study quantifying a contribution of one or more architectural components of the system 10 according to one embodiment, evaluated on the held-out multilingual evaluation corpus described above in connection with FIG. 4 and FIG. 5. Each bar of FIG. 8 corresponds to a configuration of the system 10 in which one or more components have been removed or disabled relative to a baseline configuration, and a height of each bar represents an aggregate accuracy produced by the corresponding configuration on the evaluation corpus.

The configurations of the ablation study include a full configuration, a no-NER-feature configuration, a no-post-filter configuration, a no-second-guard configuration, a no-third-guard configuration, and a no-fourth-guard configuration. The full configuration includes all components of the system 10 as described above in connection with FIG. 1 through FIG. 3, including the late-fusion concatenation module 66 receiving the pooled representation 56 from the shared multilingual transformer encoder 54 and the NER feature vector 64 from the NER feature extraction module 14, and including the multi-guard post-filter chain module 20 with all of the first guard 82, the second guard 84, the third guard 86, and the fourth guard 88 engaged. The no-NER-feature configuration disables the NER feature path 52 of FIG. 2, such that the classification head 70 receives the pooled representation 56 alone as input rather than the joint representation 68. The no-post-filter configuration disables the multi-guard post-filter chain module 20, such that the final decision 90 is produced from the entity-mention probability 72 alone by comparison against the configurable threshold. The no-second-guard, no-third-guard, and no-fourth-guard configurations disable the second guard 84, the third guard 86, and the fourth guard 88 individually, respectively, while leaving the remaining components of the system 10 unchanged.

Referring to FIG. 8, the full configuration produces an aggregate accuracy of approximately 95.77 percent and an aggregate precision of approximately 99.87 percent. The no-NER-feature configuration produces an aggregate accuracy of approximately 93.12 percent and an aggregate precision of approximately 94.23 percent, corresponding to a change in accuracy of approximately negative 2.65 percentage points relative to the full configuration. The no-post-filter configuration produces an aggregate accuracy of approximately 94.88 percent and an aggregate precision of approximately 96.54 percent, corresponding to a change in accuracy of approximately negative 0.89 percentage points relative to the full configuration. The no-second-guard configuration produces an aggregate accuracy of approximately 95.23 percent and an aggregate precision of approximately 98.12 percent, corresponding to a change in accuracy of approximately negative 0.54 percentage points relative to the full configuration. The no-third-guard configuration produces an aggregate accuracy of approximately 95.45 percent and an aggregate precision of approximately 99.01 percent, corresponding to a change in accuracy of approximately negative 0.32 percentage points relative to the full configuration. The no-fourth-guard configuration produces an aggregate accuracy of approximately 95.61 percent and an aggregate precision of approximately 99.45 percent, corresponding to a change in accuracy of approximately negative 0.16 percentage points relative to the full configuration.

The ablation results of FIG. 8 establish a contribution of the NER feature augmentation provided by the NER feature extraction module 14 and a contribution of the multi-guard post-filter chain module 20 to the aggregate performance metrics of the system 10. The NER feature augmentation contributes a largest individual accuracy improvement of approximately 2.65 percentage points over the no-NER-feature configuration, validating an empirical effectiveness of the late-fusion concatenation of the pooled representation 56 with the NER feature vector 64 at the late-fusion concatenation module 66.

The multi-guard post-filter chain module 20 contributes an accuracy improvement of approximately 0.89 percentage points collectively over the no-post-filter configuration. The second guard 84 contributes a largest individual guard contribution of approximately 0.54 percentage points, the third guard 86 contributes a contribution of approximately 0.32 percentage points, and the fourth guard 88 contributes a contribution of approximately 0.16 percentage points. The contribution of the first guard 82 is not separately ablated in FIG. 8 because the first guard 82 establishes a baseline candidate set for the second guard 84, the third guard 86, and the fourth guard 88, and is engaged in all configurations of the ablation study other than the no-post-filter configuration.

Removal of the plurality of sequential guards from the multi-guard post-filter chain module 20, as in the no-post-filter configuration, has been empirically observed to increase a false-positive rate by a factor of approximately 5.2 relative to the full configuration, while producing only a marginal corresponding improvement in recall. This observation supports a precision-biased operating regime of the system 10 as a whole, and identifies the multi-guard post-filter chain module 20 as a principal mechanism by which precision is maintained at the operating point of the configurable threshold of 0.70 in an embodiment.

The ablation results of FIG. 8 establish that the late-fusion concatenation of the pooled representation 56 with the NER feature vector 64 at the late-fusion concatenation module 66, and the script-aware multi-guard post-filter chain module 20, contribute independently and complementarily to the aggregate performance metrics of the system 10. Removal of either contribution produces a measurable degradation in accuracy and precision relative to the full configuration.

### § 3.0 Comparison With Alternative Approaches

The system 10 was compared against three baseline approaches commonly applied to entity-mention detection in enterprise content inspection deployments. The baseline approaches include a keyword blocklist approach, a regular-expression-based matching approach, and a large language model based classification approach.

The keyword blocklist approach performs case-insensitive substring matching of an item of text against a configured list of entity names, returning a triggered decision when any entity name appears as a substring of the item of text. The keyword blocklist approach has been empirically observed to produce an aggregate accuracy of approximately 72.3 percent and an aggregate precision of approximately 45.2 percent on an evaluation corpus comparable to the held-out multilingual evaluation corpus described above in connection with FIG. 4 and FIG. 5, at a latency of less than one millisecond per request. The keyword blocklist approach is limited by substring-collision false positives in which an entity name appears as a subsequence within an unrelated word of the item of text, and by an operational burden of maintaining per-language blocklists across the plurality of supported languages. The keyword blocklist approach further does not perform contextual disambiguation of entity names that are also common nouns in the supported languages.

The regular-expression-based matching approach improves on the keyword blocklist approach by enforcing word-boundary anchors at boundaries of an entity name within the item of text. The regular-expression-based matching approach has been empirically observed to produce an aggregate accuracy of approximately 81.7 percent and an aggregate precision of approximately 78.4 percent on the evaluation corpus, at a latency of less than five milliseconds per request. The regular-expression-based matching approach is effective for whitespace-delimited Latin-script languages but is limited in two respects. First, the regular-expression-based matching approach fails for CJK scripts in which whitespace tokenization does not apply, and a word-boundary anchor cannot be reliably positioned at the boundary of an entity name. Second, the regular-expression-based matching approach fails for morphologically rich target languages in which an entity name is concatenated with one or more inflectional or derivational suffixes within a single orthographic token, exceeding a fixed tolerance window of the regular-expression pattern.

The large language model based classification approach applies a generative large language model to the item of text together with a prompt directing the large language model to determine whether the item of text contains a mention of an entity drawn from a configured entity list. The large language model based classification approach has been empirically observed to produce an aggregate accuracy of approximately 94.2 percent and an aggregate precision of approximately 91.8 percent on the evaluation corpus, at a latency in a range of approximately one second to approximately five seconds per request. The large language model based classification approach offers contextual understanding of the item of text but is limited by the high latency, which is incompatible with real-time inline inspection of items of text traversing an enterprise application gateway, and by non-deterministic output behavior in which an identical item of text produces different determinations across repeated invocations of the large language model. The non-deterministic output behavior complicates compliance auditing of the determinations produced by the large language model based classification approach and complicates regression testing of changes to the large language model or to the prompt.

The system 10, in the embodiment described above in connection with FIG. 1 through FIG. 3 and as characterized by the aggregate performance metrics of FIG. 4 and FIG. 5, produces an aggregate accuracy of approximately 95.77 percent and an aggregate precision of approximately 99.87 percent on the evaluation corpus, at a 95th-percentile end-to-end inference latency of approximately 350 milliseconds. The system 10 thereby produces a higher aggregate accuracy and a higher aggregate precision than each of the keyword blocklist approach, the regular-expression-based matching approach, and the large language model based classification approach, at a latency intermediate between the regular-expression-based matching approach and the large language model based classification approach. The system 10 further supports the 28 target languages and 7 script families of the evaluation corpus uniformly, without per-language blocklist maintenance and without language-specific regular-expression patterns, and produces deterministic output behavior in which an identical item of text produces an identical final decision 90 across repeated invocations of the system 10.

The system 10 thereby occupies a region of an accuracy-precision-latency design space that is not occupied by any of the keyword blocklist approach, the regular-expression-based matching approach, or the large language model based classification approach. The combination of (i) contextual disambiguation provided by the shared multilingual transformer encoder 54 and the joint representation 68 produced by the late-fusion concatenation module 66, (ii) substring-collision suppression and false-positive control provided by the multi-guard post-filter chain module 20, and (iii) sub-second deterministic inference produced by the parallel execution of the encoder path 50 and the NER feature path 52, distinguishes the system 10 from each of the baseline approaches and supports deployment of the system 10 for real-time inline inspection of items of text traversing enterprise application gateways.

### § 4.0 Production Deployment

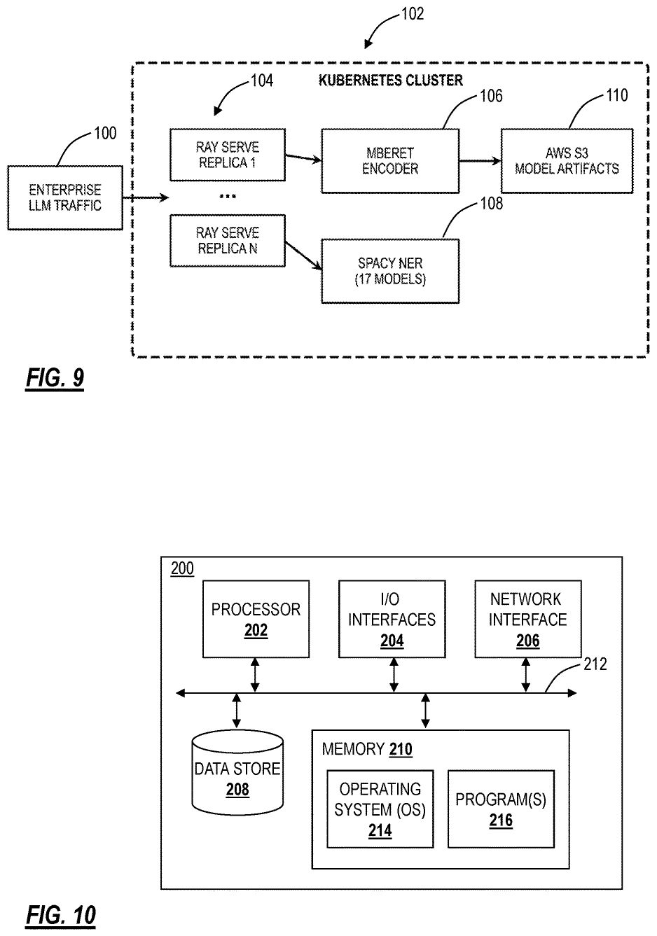

FIG. 9 is a diagram of a production deployment architecture of the system 10 according to one embodiment. The production deployment architecture includes an inbound traffic stream 100 of items of text originating from one or more enterprise applications, a container orchestration platform 102 hosting a serving framework 104 with one or more autoscaling replicas, a transformer encoder runtime 106 executing the shared multilingual transformer encoder 54 of FIG. 2, an NER engine runtime 108 executing the NER engine 60 of FIG. 2, and a cloud object storage 110 storing one or more model artifacts for the system 10.

The inbound traffic stream 100 includes items of text originating from one or more enterprise applications, including a large language model (LLM) inference endpoint, a chatbot platform, a content generation pipeline, an internal knowledge assistant, a document authoring tool, and a gateway for items of text in transit through an enterprise application infrastructure. Each item of text of the inbound traffic stream 100 is received by the input receiver 12 of FIG. 1 together with a configured entity list and a configurable threshold, as described above in connection with FIG. 1.

The container orchestration platform 102 hosts the system 10 as one or more containers scheduled across a plurality of compute nodes. In an embodiment, the container orchestration platform 102 is implemented as a Kubernetes cluster. In other embodiments, the container orchestration platform 102 is implemented as a different container orchestration platform supporting horizontal scaling and rolling updates of the one or more containers.

The serving framework 104 hosts the system 10 within the container orchestration platform 102 as a serving deployment exposing a request handler over a network protocol. In an embodiment, the serving framework 104 is implemented as a Ray Serve deployment with one or more autoscaling replicas, each autoscaling replica including an instance of the system 10. The one or more autoscaling replicas scale horizontally responsive to a request rate of the inbound traffic stream 100, with additional replicas instantiated when the request rate exceeds a predetermined upper threshold and replicas decommissioned when the request rate falls below a predetermined lower threshold for a predetermined duration. In other embodiments, the serving framework 104 is implemented as a different model-serving framework supporting horizontal scaling and request batching.

The transformer encoder runtime 106 executes the shared multilingual transformer encoder 54 of FIG. 2 within each autoscaling replica of the serving framework 104. In an embodiment, the transformer encoder runtime 106 performs forward-pass computation using mixed-precision arithmetic, including 16-bit floating-point (FP16) arithmetic on a graphics processing unit (GPU) accelerator when a GPU accelerator is available, and 32-bit floating-point (FP32) arithmetic on a central processing unit (CPU) when a GPU accelerator is not available. In an embodiment, the mixed-precision arithmetic is dispatched via an automatic mixed-precision facility of a deep learning framework. The transformer encoder runtime 106 in one embodiment maintains the shared multilingual transformer encoder 54 in memory across requests, eliminating model-loading overhead on a per-request basis.

The NER engine runtime 108 executes the NER engine 60 of FIG. 2 within each autoscaling replica of the serving framework 104. In an embodiment, the NER engine runtime 108 loads a plurality of per-language NER archives into memory at startup and caches the loaded NER archives across requests. In one embodiment, the NER engine runtime 108 loads 17 dedicated per-language spaCy archives into memory at startup. The per-language NER archives are extracted from a packaged-archive form to an unpacked form on a writable pod-local volume at startup, with the unpacked form cached on the writable pod-local volume to avoid re-extraction on subsequent requests served by the same autoscaling replica.

The cloud object storage 110 stores one or more model artifacts for the system 10, including a weights file for the shared multilingual transformer encoder 54, a state dictionary for the classification head 70, and the plurality of per-language NER archives loaded by the NER engine runtime 108. At startup of each autoscaling replica of the serving framework 104, the one or more model artifacts are downloaded from the cloud object storage 110 to the autoscaling replica, the transformer encoder weights are loaded into the transformer encoder runtime 106, the classification head state dictionary is loaded into the classification head 70, and the per-language NER archives are loaded into the NER engine runtime 108. In an embodiment, the cloud object storage 110 is implemented as Amazon Web Services (AWS) Simple Storage Service (S3). In other embodiments, the cloud object storage 110 is implemented as a different cloud object storage system or as a network-attached file system accessible to the autoscaling replicas of the serving framework 104.

In one production embodiment, a data loader of the transformer encoder runtime 106 is configured with a worker-process count of zero, in which subword tokenization by the transformer tokenizer 16 and tensor preparation for the shared multilingual transformer encoder 54 are performed within a main process of the autoscaling replica rather than in forked subprocess workers. Configuration of the worker-process count to zero has been empirically observed to reduce an end-to-end inference latency from approximately 1,650 milliseconds to approximately 350 milliseconds, by avoiding a forked-subprocess cache invalidation that otherwise occurs when a forked subprocess worker accesses a cached NER archive or a cached transformer encoder weight.

The production deployment of FIG. 9 supports a plurality of enterprise use cases for the system 10. In a first use case, the system 10 operates as an inline inspection layer between the LLM inference endpoint and an end user, the system 10 receiving each response generated by the LLM inference endpoint, producing the final decision 90 for the response, and conditionally admitting, redacting, or blocking the response based on the final decision 90. In a second use case, the system 10 operates as a pre-publication screening layer for a content generation pipeline producing items of text for distribution in multilingual marketing campaigns, with the final decision 90 controlling whether a generated item of text proceeds to publication or is held for human review. In a third use case, the system 10 operates as a real-time inspection layer for an internal knowledge assistant of an enterprise, with the final decision 90 controlling whether a response of the internal knowledge assistant is delivered to a requesting employee or is suppressed in favor of an alternate response. In a fourth use case, the system 10 operates as a policy-enforcement layer for items of text traversing a gateway for regulated-industry communications, with the configurable threshold of the pre-guard stage 80 set to a value reflecting a sensitivity level appropriate to a regulatory environment of the deployment.

The system 10 in one embodiment is integrated with a cybersecurity monitoring infrastructure of the enterprise. In one embodiment, the final decision 90 produced by the system 10 is emitted as a structured event to a security information and event management (SIEM) system, the structured event including a timestamp of the determination, an identifier of the requesting enterprise application, a hash or excerpt of the item of text, the entity-mention probability 72, the final decision 90, and a script-family label of the item of text. The structured event supports downstream correlation by the SIEM system with other security events of the enterprise, including data loss prevention (DLP) events, cloud access security broker (CASB) events, and user behavior analytics (UBA) events.

In another embodiment, the system 10 is integrated with a data loss prevention (DLP) policy engine of the enterprise, the final decision 90 contributing to a policy determination by the DLP policy engine as to whether to admit, block, quarantine, or redact an item of text in transit through an enterprise application gateway. The DLP policy engine in one embodiment combines the final decision 90 produced by the system 10 with one or more additional content classifications, including a sensitive-data classification, a regulated-data classification, or a policy-violation classification, to produce a composite policy determination.

In a further embodiment, the system 10 is integrated with a cloud access security broker (CASB) platform of the enterprise, the final decision 90 informing access-control decisions by the CASB platform with respect to one or more cloud applications used by the enterprise. The system 10 in this embodiment inspects items of text traversing the CASB platform between an enterprise endpoint and a cloud application, and the final decision 90 contributes to a per-application or per-user policy decision by the CASB platform.

In a still further embodiment, the system 10 is integrated with a security operations center (SOC) workflow of the enterprise, the final decision 90 producing an alert to be triaged by a security analyst when the final decision 90 indicates a triggered status and one or more secondary conditions are satisfied. The one or more secondary conditions in various embodiments include a user-role condition, an application-sensitivity condition, a regulatory-jurisdiction condition, or an aggregate-volume condition over a sliding window of items of text inspected by the system 10. The alert in one embodiment includes a context window of the item of text surrounding a candidate entity mention, the entity-mention probability 72, the final decision 90, and a structured indication of which of the plurality of sequential guards of the multi-guard post-filter chain module 20 admitted the candidate entity mention.

In a still further embodiment, the system 10 is integrated with a zero trust network access (ZTNA) gateway of the enterprise, the final decision 90 contributing to a session-level or request-level access decision by the ZTNA gateway with respect to items of text in transit between an enterprise endpoint and a protected resource. The ZTNA gateway in one embodiment terminates a session or rejects a request when the final decision 90 indicates a triggered status and the protected resource is classified as sensitive under a configured policy of the ZTNA gateway.

In a still further embodiment, the system 10 emits structured audit-log records to an audit-logging infrastructure of the enterprise, each audit-log record including the final decision 90, the entity-mention probability 72, the configurable threshold against which the entity-mention probability 72 was compared, the script-family label of the item of text, an indication of whether the script-aware bypass was activated, and a non-content identifier of the item of text supporting downstream correlation without disclosing content of the item of text. The structured audit-log records support compliance reporting and regulatory audit obligations of the enterprise.

### § 5.0 Example Computing System Architecture

FIG. 10 is a block diagram of an example computing system 200 that may be used to implement one or more components of the system 10 described above in connection with FIG. 1 through FIG. 9. The computing system 200 may take various forms, including, without limitation, a laptop, a desktop, a physical server, a cluster of machines, a virtual machine (VM) executing on a hypervisor, a containerized workload scheduled on the container orchestration platform 102 of FIG. 9, or a serverless computing framework. The computing system 200 includes one or more processors 202, input/output (I/O) interfaces 204, a network interface 206, a data store 208, and memory 210. FIG. 10 provides a simplified representation, and additional hardware and software elements may be present. The components 202, 204, 206, 208, and 210 are coupled by way of a local interface 212, which may include one or more buses, high-speed interconnects, switching fabrics, or combinations thereof, and may further include controllers, buffers, caches, drivers, repeaters, receivers, and associated addressing and control lines.

The processor 202 may include, for example, a central processing unit (CPU), a multicore processor, a system-on-chip (SoC), a graphics processing unit (GPU), or a processing element within a distributed compute cluster. The processor 202 may be general-purpose or specialized for performance, power efficiency, or workload-specific tasks including forward-pass computation by the shared multilingual transformer encoder 54 of FIG. 2 and named-entity-recognition processing by the NER engine 60 of FIG. 2. During operation, the processor 202 executes instructions stored in the memory 210, accesses data from the data store 208, and coordinates operation of the computing system 200. In one embodiment, the processor 202 performs the forward-pass computation by the shared multilingual transformer encoder 54 using mixed-precision arithmetic, including 16-bit floating-point arithmetic on a GPU implementation of the processor 202, and 32-bit floating-point arithmetic on a CPU implementation of the processor 202, as described above in connection with the transformer encoder runtime 106 of FIG. 9. In production deployments serving a high request rate, multiple computing systems 200 may operate in parallel as the one or more autoscaling replicas of the serving framework 104 of FIG. 9.

The I/O interfaces 204 enable communication between the computing system 200 and external peripherals, supporting user input by way of, for example, a keyboard, a touchscreen, or one or more sensors, and system output by way of, for example, a display or a printer. In some implementations, the I/O interfaces 204 also support specialized devices for maintenance, debugging, or administrative tasks. The network interface 206 enables connectivity to one or more external networks, including the Internet, a private network, or a cloud environment, by way of one or more network technologies including Ethernet, a wireless local area network (LAN), a cellular link, or a virtualized network interface. The network interface 206 may support secure transport protocols and encryption to protect transmitted data, supporting deployment of the system 10 within a distributed or cloud-based infrastructure. In one embodiment, the network interface 206 receives the inbound traffic stream 100 of FIG. 9 and returns the final decision 90 of FIG. 3 to an originating enterprise application by way of a response over a network protocol.

The data store 208 provides storage for persistent and temporary data, and may include volatile memory in the form of random access memory (RAM) for high-speed operations and non-volatile media in the form of one or more solid-state drives, hard disk drives, or optical storage devices for long-term retention. In certain implementations, the data store 208 may be integrated with one or more of network-attached storage (NAS), a storage area network (SAN), or a cloud-based storage system including the cloud object storage 110 of FIG. 9. Features such as deduplication, compression, encryption-at-rest, and replication may be employed. Stored data may include operational logs, configuration data, policy definitions, executable binaries, cached results, the one or more model artifacts maintained by the cloud object storage 110, and the plurality of per-language NER archives loaded by the NER engine runtime 108 of FIG. 9.

The memory 210 serves as working memory for the processor 202, and may include volatile components in the form of dynamic RAM (DRAM), double data rate (DDR) memory, or synchronous DRAM (SDRAM), and non-volatile components in the form of flash memory or non-volatile RAM (NVRAM). In some implementations, the memory 210 is distributed across multiple nodes to support large-scale in-memory processing. The memory 210 stores an operating system 214 that manages processes including scheduling, memory allocation, file management, and networking, and one or more programs 216 that, when executed by the processor 202, cause the computing system 200 to implement one or more functions described herein. In one embodiment, the one or more programs 216 implement the input receiver 12, the NER feature extraction module 14, the transformer tokenizer 16, the neural inference module 18, the multi-guard post-filter chain module 20, and the result output 22 of FIG. 1.

The computing system 200 may be deployed in a variety of cloud configurations, including a private cloud hosted within a datacenter of an enterprise, a public cloud hosted by a third-party provider, or a hybrid cloud combining a private cloud and a public cloud. Cloud computing abstracts physical hardware into on-demand, scalable resources, supporting dynamic provisioning of compute, storage, and networking. The U.S. National Institute of Standards and Technology (NIST) defines cloud computing as “a model for enabling convenient, on-demand network access to a shared pool of configurable computing resources . . . that can be rapidly provisioned and released with minimal management effort or service provider interaction.” In Software-as-a-Service (SaaS) deployments of the system 10, applications are delivered by way of a web interface or a network application programming interface (API), supporting centralized update of the system 10, security patching, and feature release.

Various embodiments may use different forms of processing circuitry, including a general-purpose microprocessor, a digital signal processor (DSP), a network processor, a GPU, a field-programmable gate array (FPGA), a programmable logic device (PLD), or an application-specific integrated circuit (ASIC). The processing circuitry may be controlled by software, firmware, or combinations thereof, and may be supplemented by non-processor circuits including a state machine. Implementations may include a non-transitory computer-readable storage medium having stored thereon instructions that, when executed by the processing circuitry, cause the computing system 200 to perform one or more methods described herein, including a method of detecting entity mentions in multilingual text by way of the system 10 of FIG. 1. Examples of the non-transitory computer-readable storage medium include a hard disk, optical media, magnetic media, read-only memory (ROM) and variants thereof, flash memory, and other persistent or semi-persistent storage devices.

### § 6.0 Conclusion

In this disclosure, including the claims, the phrases “at least one of” and “one or more of,” when referring to a list of items, encompass any individual item as well as any combination of the listed items. For example, the expressions “at least one of A, B, or C,” “at least one of A, B, and C,” “one or more of A, B, or C,” and “one or more of A, B, and C” cover only A; only B; only C; any combination of two of A, B, and C; or all three of A, B, and C. The terms “comprise,” “comprises,” “comprising,” “include,” “includes,” and “including” are intended to be open-ended and non-limiting, such that the recited elements, components, or steps do not exclude the presence or addition of one or more other elements, components, or steps.

The drawings, descriptions, and examples provided herein are for purposes of illustration and explanation and are not to be construed as limiting. Modifications, substitutions, additions, omissions, or rearrangements may be made without departing from the spirit and scope of the disclosure. Although certain steps, operations, instructions, blocks, or similar elements (collectively, “steps”) may be depicted or described in a particular order, such order is not required unless expressly stated, and does not imply that all steps are necessary. Steps may be performed before, after, concurrently with, or interleaved among other steps. Parallel execution, pipelining, multitasking, and other concurrent techniques are contemplated, including the parallel execution of the encoder path 50 and the NER feature path 52 described above in connection with FIG. 2. Further, the partitioning of system components, modules, or functions described herein is illustrative, and such components, modules, or functions may be combined, subdivided, replicated, or distributed across one or more devices or entities, including across the one or more autoscaling replicas of the serving framework 104 described above in connection with FIG. 9.

While the disclosure has been described with reference to particular embodiments and examples, those skilled in the art will appreciate that variations, modifications, and alternative implementations may provide equivalent functionality or comparable results. Such alternatives, whether or not expressly described, are within the scope of the disclosure if they are consistent with the principles described herein. Accordingly, the present disclosure encompasses combinations, permutations, and arrangements of the described elements, operations, methods, processes, algorithms, functions, techniques, modules, and circuits, whether implemented collectively, separately, or in subsets.

What is claimed is:

1. A computer-implemented method of detecting entity mentions in multilingual text, the method comprising:
receiving an item of text and a configured entity list;
producing a named-entity-recognition (NER) feature vector from the item of text and the configured entity list;
producing a pooled representation by applying a shared multilingual transformer encoder to a tokenized representation of the item of text;
producing a joint representation by concatenating the pooled representation with the NER feature vector after and external to encoder layers of the shared multilingual transformer encoder;
producing an entity-mention probability from the joint representation through a classification head;
determining a script family of the item of text; and
producing a final decision based on comparing the entity-mention probability to a configurable threshold and applying a multi-guard post-filter chain, wherein at least one guard of the multi-guard post-filter chain is short-circuited in response to the script family being a non-Latin script family.

2. The method of claim 1, wherein the shared multilingual transformer encoder comprises a multilingual transformer pretrained on a corpus spanning a plurality of languages and a plurality of script families, the shared multilingual transformer encoder having a hidden dimension.

3. The method of claim 1, wherein the pooled representation comprises an embedding of a classification token extracted at a predetermined token position of a sequence of contextualized token embeddings produced by the shared multilingual transformer encoder.

4. The method of claim 1, wherein the NER feature vector comprises an exact-match feature, a fuzzy-similarity feature, an entity-overlap feature, an organization-entity feature, a position-score feature, and a mention-frequency feature, each normalized to a predetermined interval.

5. The method of claim 4, wherein the exact-match feature is computed by a Chinese-Japanese-Korean (CJK) aware substring matcher that performs case-folded substring containment testing without enforcement of whitespace word-boundary constraints in response to detecting characters drawn from a CJK script in the item of text.

6. The method of claim 4, wherein the fuzzy-similarity feature is computed by a length-gated similarity function applied between an entity name in the configured entity list and a sliding window of the item of text, a length gating restricting the sliding window to a length within a predetermined factor of a length of the entity name.

7. The method of claim 4, wherein the entity-overlap feature is computed as a ratio of entity spans, produced by an NER engine, matching an entity name in the configured entity list to a total count of entity spans produced by the NER engine, and wherein the organization-entity feature is computed as the entity-overlap feature restricted to entity spans having an entity type label corresponding to an organization.

8. The method of claim 4, wherein the position-score feature is computed based on a character position of a first occurrence of an entity name from the configured entity list within the item of text and a total character length of the item of text, and wherein the mention-frequency feature is computed based on a count of occurrences of entity names from the configured entity list within the item of text and a total count of entity spans produced by an NER engine, with a saturation applied at a predetermined maximum value.

9. The method of claim 1, wherein the producing the NER feature vector and the producing the pooled representation are performed concurrently on independent code paths, and wherein the joint representation has a dimension equal to a sum of a dimension of the pooled representation and a dimension of the NER feature vector.

10. The method of claim 1, wherein the classification head comprises a plurality of fully-connected layers, each fully-connected layer of the plurality of fully-connected layers other than a final fully-connected layer being followed by layer normalization, a rectified linear unit (ReLU) activation, and dropout regularization, and the final fully-connected layer being followed by softmax normalization.

11. The method of claim 1, wherein the multi-guard post-filter chain comprises, in order of increasing strictness, a first guard implementing lenient-substring matching, a second guard implementing word-boundary matching, a third guard implementing fuzzy-similarity matching, and a fourth guard implementing all-capitals ticker-detection matching.

12. The method of claim 11, wherein the first guard performs case-folded substring containment testing of an entity name from the configured entity list against the item of text, applying a suffix tolerance window admitting a predetermined number of additional characters following the entity name.

13. The method of claim 11, wherein the second guard applies a regular-expression word-boundary anchor for items of text in Latin-script languages, and falls back to behavior of the first guard for items of text containing Chinese-Japanese-Korean (CJK) script characters.

14. The method of claim 11, wherein the third guard applies a similarity comparison at a predetermined similarity threshold with leetspeak rejection implemented by character-class normalization mapping digit-for-letter substitutions to canonical alphabetic forms prior to the similarity comparison.

15. The method of claim 11, wherein the fourth guard applies a similarity comparison at a predetermined similarity threshold to tokens of the item of text composed entirely of uppercase alphabetic characters and having a length within a predetermined range.

16. The method of claim 11, wherein in response to the script family being a non-Latin script family, the second guard, the third guard, and the fourth guard are short-circuited and the final decision is produced based on the entity-mention probability exceeding the configurable threshold.

17. The method of claim 1, wherein the non-Latin script family includes one or more of Arabic, Chinese, Japanese, Korean, Devanagari, Greek, Hebrew, Cyrillic, and Thai scripts, and wherein the determining the script family comprises examining Unicode code-point ranges of characters in the item of text.

18. The method of claim 1, further comprising rejecting a candidate entity mention identified by the multi-guard post-filter chain in response to a context-verification result, produced by a business-context verification unit based on proximity of the candidate entity mention to one or more business-context indicator tokens of a configured lexicon, being below a predetermined verification threshold.

19. A system for detecting entity mentions in multilingual text, the system comprising:
one or more processors; and memory storing instructions that, when executed by the one or more processors, cause the system to:
receive an item of text and a configured entity list;
produce a named-entity-recognition (NER) feature vector from the item of text and the configured entity list;
produce a pooled representation by applying a shared multilingual transformer encoder to a tokenized representation of the item of text;
produce a joint representation by concatenating the pooled representation with the NER feature vector after and external to encoder layers of the shared multilingual transformer encoder;
produce an entity-mention probability from the joint representation through a classification head;
determine a script family of the item of text; and
produce a final decision based on comparing the entity-mention probability to a configurable threshold and applying a multi-guard post-filter chain, wherein at least one guard of the multi-guard post-filter chain is short-circuited in response to the script family being a non-Latin script family.

20. A non-transitory computer-readable medium having stored thereon instructions which, when executed by one or more processors, cause the one or more processors to:
receive an item of text and a configured entity list;
produce a named-entity-recognition (NER) feature vector from the item of text and the configured entity list;
produce a pooled representation by applying a shared multilingual transformer encoder to a tokenized representation of the item of text;
produce a joint representation by concatenating the pooled representation with the NER feature vector after and external to encoder layers of the shared multilingual transformer encoder;
produce an entity-mention probability from the joint representation through a classification head;
determine a script family of the item of text; and
produce a final decision based on comparing the entity-mention probability to a configurable threshold and applying a multi-guard post-filter chain, wherein at least one guard of the multi-guard post-filter chain is short-circuited in response to the script family being a non-Latin script family.
